(19) United States
(12) Patent Application Publication
(10) Pub. No.: US 2003/0006542 A1
(43) Pub. Date: Jan. 9, 2003

(54) Torsion bar spring

(76) Inventors: Jens Meintschel, Esslingen (DE); Thomas Stolk, Kirchheim /Teck (DE); Rudolf Reinhardt, Esslingen (DE); Bernd Schietinger, Esslingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/128,585

(22) Filed: Apr. 24, 2002

(30) Foreign Application Priority Data
Apr. 25, 2001 (DE) 101 20 399.3

(51) Int. Cl. F16F 1/14

(52) U.S. Cl. 267/154

(57) ABSTRACT

A torsion bar spring of spring steel with a high carbon content is connected fixedly in terms of rotation at its ends to structural parts. The structural parts are mounted pivotably in relation to one another. The torsion bar spring is connected in a materially integral manner to at least one of the structural parts by friction welding, condenser discharge welding, diffusion welding or medium-frequency pressure welding via intermediate pieces. As a result, a play-free and wear-free connection between the torsion bar spring and the structural part can be made in a confined construction space, and the connection is suitable for absorbing high loads, particularly alternating loads.

This application claims the priority of German application 101 20 399.3, filed Apr. 25, 2001, the disclosure of which is expressly incorporated by reference herein.

### BACKGROUND AND SUMMARY OF THE INVENTION

The present invention relates to a torsion bar spring of spring steel, with a high carbon content, which is connected fixedly in terms of rotation at its ends to structural parts mounted pivotably in relation to one another.

German Patent Publication DE 36 16 540 A1 discloses an electromagnetic actuator for actuating a gas-exchange valve of a reciprocating-piston internal combustion engine. An armature is arranged between two electromagnets which are alternately excited periodically and at the same time attract the armature. The armature is articulated via an armature tappet on a one-armed valve lever which is pivoted back and forth counter to the spring tension of a torsion bar spring and at the same time opens and closes the gas-exchange valve. The valve lever is designed at one end as a bearing tube which is mounted on its two sides in bearing blocks. The torsion bar spring projects with one end into the bearing tube and in the region of one bearing block is connected fixedly in terms of rotation to the bearing tube. With its other end, the torsion bar spring is clamped fixedly in terms of rotation in a holding bush which is itself flanged adjustably to a cylinder head of the internal combustion engine. A serration serves as a connection between the torsion bar spring, on the one hand, and the bearing tube or the holding bush, on the other hand. So that the high alternating loads which occur can be transmitted reliably over a long operating time, the serration must have a correspondingly large dimensioning, for which there is not usually sufficient construction space available. Moreover, there is no guarantee that the serration supports uniformly and that, under a continuous alternating load, no play occurs which would increase in course of time due to the wear of the serration.

One object of the invention is to provide, in a confined construction space between a torsion bar spring and a structural part, a play-free and wear-free connection which is capable of absorbing high alternating loads. This object is achieved, along with others, by connecting the torsion bar spring to at least one of the structural parts by any of friction welding, condenser discharge welding, diffusion welding or medium-frequency pressure welding via a connection piece of a material which can be fusion welded. The torsion bar spring is first welded to the connection piece by friction welding, condenser discharge welding, diffusion welding, or medium-frequency pressure welding, and thereafter the connection piece is connected to the at least one of the structural parts by fusion welding. Advantageous refinements and developments of the invention are apparent from dependent claims.

According to the invention, the torsion bar spring is connected in a materially integral manner to at least one or both structural parts via one or two intermediate pieces by friction welding, condenser discharge welding, diffusion welding or medium-frequency pressure welding. The materially integral connection has the advantage, as compared with non-positive connections, such as press fits or conical fits, or as compared with positive connections, such as serrations, hexagons, etc., that it is play-free and wear-free, does not require such high manufacturing accuracy, and is particularly suitable for the transmission of high loads, in particular alternating loads. Since the connection itself can be made low-stress, in contrast to non-positive connections, and, in contrast to positive connections, manages with a simple rotationally symmetrical geometry which does not weaken the connection cross section by notching influences, the connection point can be kept small both in diameter and in axial extent.

The torsion bar spring is made, as a rule, of a spring steel with a high carbon content which cannot be welded in an operationally reliable way to other structural parts by a conventional fusion-welding method, such as laser welding. It is therefore proposed, according to the invention, for the materially integral connection, to connect the torsion bar spring to the other structural parts via intermediate pieces, by the torsion bar spring first being welded to the connection piece by friction welding, condenser discharge welding, diffusion welding or medium-frequency pressure welding, and by the connection piece subsequently being connected to the structural part by means of conventional fusion welding, for example a laser-beam welding method. It is thus possible to make an operationally reliable materially integral connection between the torsion bar spring and the connection piece and thereupon to produce an identical connection between the connection piece and the structural part by means of a conventional fusion-welding method which does not require special method preconditions.

A material suitable for the connection piece is a steel with a relatively low carbon content which can be welded by means of conventional welding methods, for example a commercially available 16MnCr5 steel (Mn=Manganese; Cr=Chromium). Depending on the structural conditions, the connection piece may advantageously be welded with one end face or with the circumference to the end of the torsion bar spring. Instead of a connection piece, a connection layer having the same properties as the connection piece may also be applied to the torsion bar spring. Expediently, the torsion bar spring is heat-treated and finally machined after the connection piece is welded or the connection layer applied.

The torsion bar spring according to the invention is used advantageously in an actuator with an armature which is mounted pivotably in a pivot bearing between two electromagnets. The construction space conditions are particularly confined here. By virtue of the measures according to the invention, it is possible to accommodate a torsion bar spring with sufficient spring force and spring length and to utilize the existing construction space optimally both in length and in diameter. For this purpose, the torsion bar spring is arranged in a bore, a hub or a bearing sleeve which is an integral part of a pivot bearing of an armature of an actuator which actuates a gas-exchange valve of an internal combustion engine. The hub or the bearing sleeve is pivotably mounted at one end, on its outer circumference, by means of a bearing in a housing, for example the housing of the actuator, or in the cylinder head itself. The torsion bar spring is accommodated in the bore of the bearing sleeve and, according to the invention, is connected at one end to the bearing sleeve in the region of the bearing. The other end of the torsion bar spring which projects out of the bearing sleeve may be connected in the same way to the housing of the actuator or the cylinder head. Near this connection point, the hub or the bearing sleeve is expediently pivotably mounted on the torsion bar spring by means of a bearing.

Further advantages may be gathered from the following description. Exemplary embodiments of the invention are illustrated in the drawings. The description and the claims contain numerous features in combination. A person skilled in the art will expediently also consider the features individually and combine them into appropriate further combinations. A process of connecting the torsion bar spring is also claimed.

### BRIEF DESCRIPTION OF THE DRAWINGS

FIG. 1 shows a diagrammatic part-section through a cylinder head of a reciprocating-piston internal combustion engine with an actuator,

FIG. 2 shows a section along the line II-II in FIG. 1,

FIG. 3 shows an enlarged detail along the line III-III in FIG. 2, and

FIG. 4 shows a variant of FIG. 3.

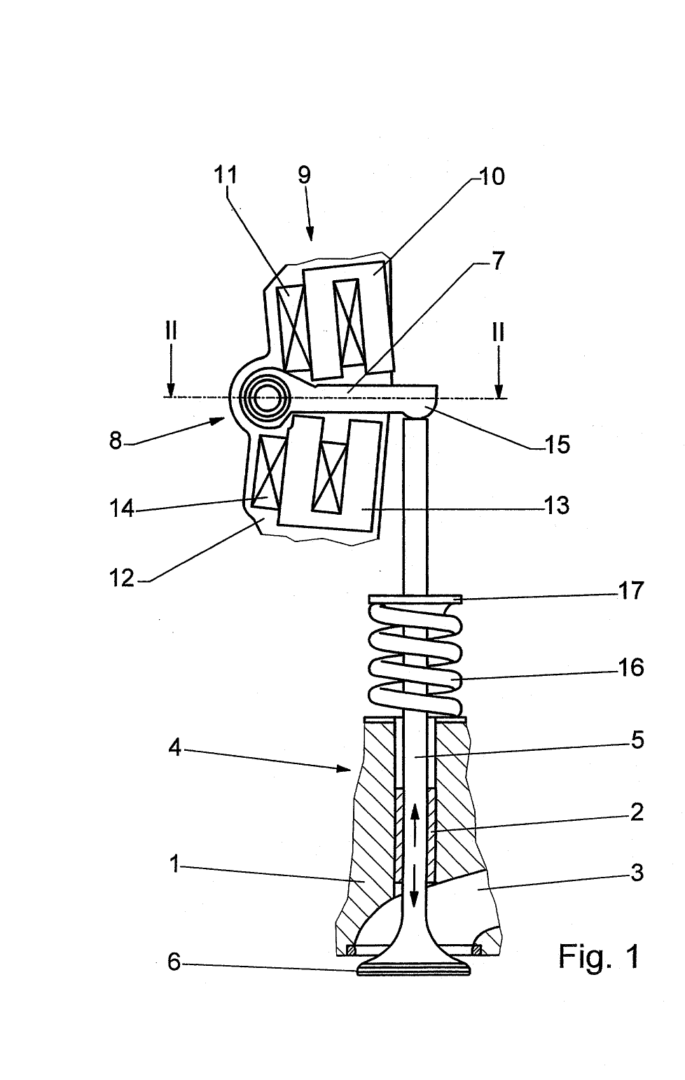

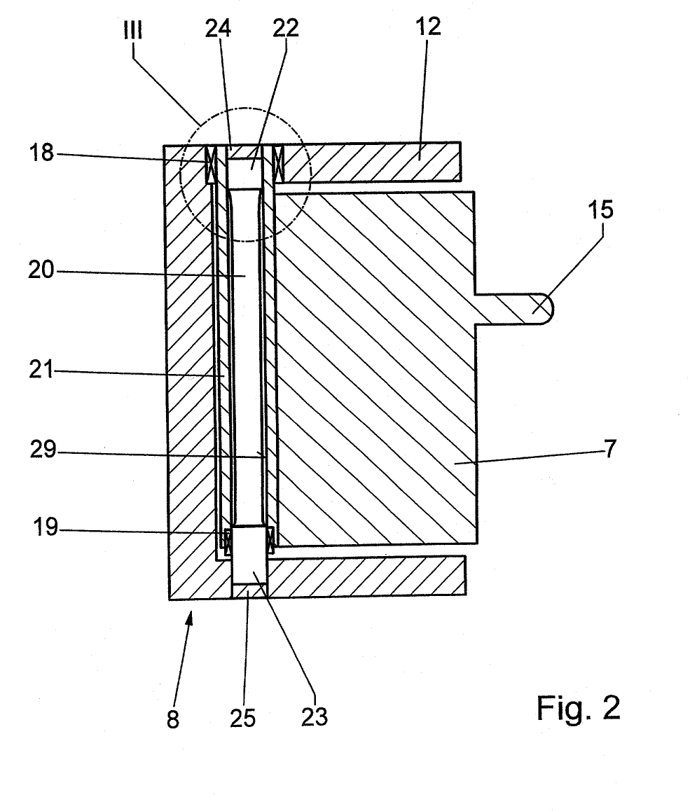

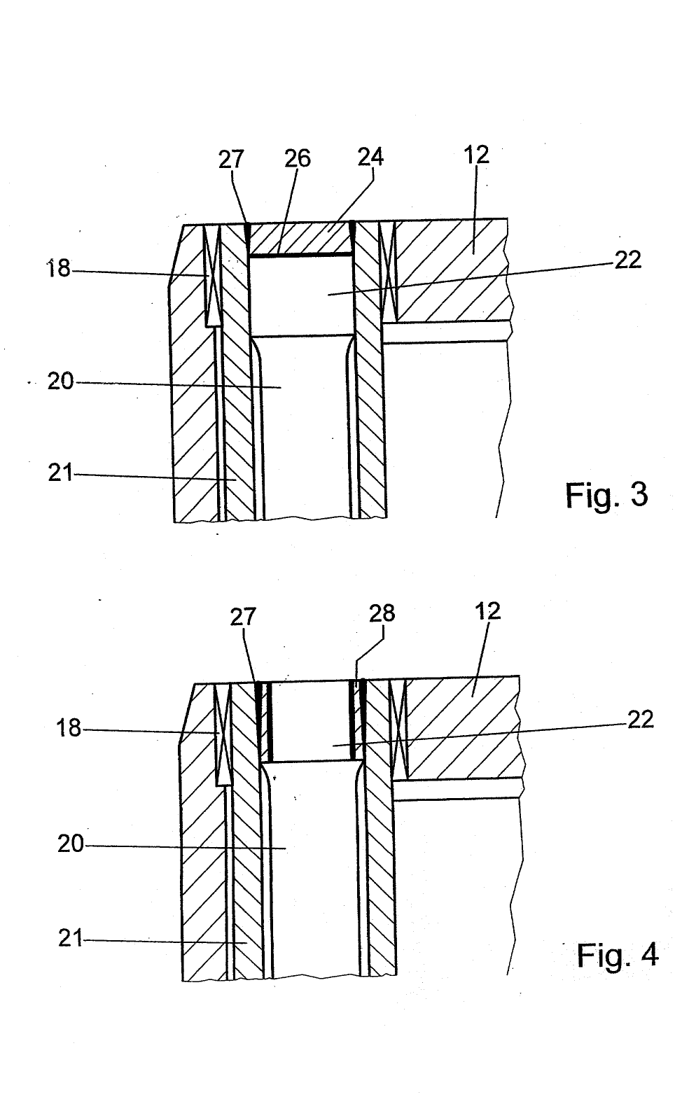

### DETAILED DESCRIPTION OF THE INVENTION

A gas-exchange duct 3, which is controlled by a gas-exchange valve 4 with a valve disc 6, is provided in a cylinder head 1 of a reciprocating-piston internal combustion engine, not illustrated in any more detail. The gas-exchange valve 4, the valve stem 5 of which is guided in the cylinder head 1 by means of a valve guide 2, is loaded in a closing direction by a valve spring 16. The latter is supported at one end on the valve stem 5 via a spring plate 17 and at its other end on the cylinder head 1.

The gas-exchange valve 4 is actuated by an actuator 9. The latter possesses two electromagnets, of which the upper is formed by a yoke 10 and a magnet coil 11 and the lower by a yoke 13 and a magnet coil 14. The electromagnets 10, 11 and 13, 14 are accommodated in a housing 12, in which an armature 7 is pivotably mounted in a pivot bearing 8 between the electromagnets 10, 11 and 13, 14. The armature 7 possesses at its free end a finger 15, by means of which it actuates the valve stem 5 of the gas-exchange valve 4.

Connected to the armature 7 in the region of the pivot bearing 8 is a hub in the form of a bearing sleeve 21 which is pivotably mounted at one end, on its outer circumference, by means of a bearing 18 in the housing 12 of the actuator 9 and has a central bore 29, in which a torsion bar spring 20 is accommodated. The latter is connected in a materially integral manner in the region of the bearing 18, at one end 22, to the bearing sleeve 21 via a connection piece 24 by first being welded on its end face to the connection piece 24 by friction welding, condenser discharge welding, diffusion welding or medium-frequency pressure welding, with the result that a weld seam 26 is obtained. The connection piece 24 is thereafter welded to the bearing sleeve 21 by means of a conventional fusion-welding method, a weld seam 27 being formed. The connection piece 24 is produced from a material which can both be connected to the torsion bar spring 20 by means of the methods mentioned and be welded to the bearing sleeve 21 by means of conventional welding methods. The torsion bar spring 20 projects with its other end 23 out of the bearing sleeve 21 and engages into a bore 29 of the housing 12, to which it can be connected in a materially integral manner in the same way via a connection piece 25. The bearing sleeve 21 is pivotably mounted at this end, by means of a bearing 19 inserted into the central bore 29, on the torsion bar spring 20 or a housing connection piece surrounding the torsion bar spring 20.

FIG. 4 shows a variant, in which a connection layer 28 is applied to the torsion bar spring 20 on the circumference of the end 22, the connection layer possessing the same properties as the connection pieces 24 and 25 and therefore being capable of being connected to the bearing sleeve 21, for example, by laser-beam welding. The connection layer 28 may also be replaced by a corresponding sleeve-shaped connection piece which is welded to the torsion bar spring 20 in the same way as the connection piece 24, 25.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A torsion bar spring of spring steel with a high carbon content, which is connected fixedly in terms of rotation at its ends to structural parts, the structural parts being mounted pivotably in relation to one another, wherein the torsion bar spring is connected to at least one of the structural parts by any of friction welding, condenser discharge welding, diffusion welding or medium-frequency pressure welding via a connection piece of a material which can be fusion welded, and wherein the torsion bar spring is first welded to the connection piece by friction welding, condenser discharge welding, diffusion welding, or medium-frequency pressure welding, and thereafter the connection piece is connected to the at least one of the structural parts by fusion welding.

2. The torsion bar spring according to claim 1, wherein the fusion welding is laser-beam welding.

3. The torsion bar spring according to claim 1, wherein the connection piece has a carbon content such that the connection piece can be welded by conventional welding methods.

4. The torsion bar spring according to claim 3, wherein the connection piece is produced from a 16MnCr5 steel.

5. The torsion bar spring according to claim 1, wherein the connection piece is welded to one end face of the torsion bar spring.

6. The torsion bar spring according to claim 1, wherein the connection piece is welded to the circumference of the torsion bar spring.

7. The torsion bar spring according to claim 2, wherein a connection layer is applied to the torsion bar spring instead of said connection piece.

8. The torsion bar spring according to claim 7, wherein the torsion bar spring is heat-treated and finally machined after welding to the connection piece or application of the connection layer.

9. The torsion bar spring according to claim 2, wherein the torsion bar spring is arranged in a bore of a hub or bearing sleeve, defining one of said structural parts, which is an integral part of a pivot bearing of an armature of an actuator which actuates a gas-exchange valve of an internal combustion engine.

10. The torsion bar spring according to claim 9, wherein the hub or bearing sleeve is pivotably mounted at one end, on its outer circumference, by a bearing in a housing, defining another of said structural parts, and is connected in its bore to one end of the torsion bar spring in the region of the bearing.

11. The torsion bar spring according to claim 10, wherein the torsion bar spring is connected at its other end to the housing, and the hub or the bearing sleeve is pivotably mounted in its bore near the other end on the torsion bar spring by a bearing.

12. A process of connecting a torsion bar spring of spring steel with a high carbon content, which is connected fixedly in terms of rotation at its ends to structural parts, the structural parts being mounted pivotably in relation to one another, the torsion bar spring being connected to at least one of the structural parts by any of friction welding, condenser discharge welding, diffusion welding or medium-frequency pressure welding via a connection piece of a material which can be fusion welded, comprising:
welding the torsion bar spring to the connection piece by friction welding, condenser discharge welding, diffusion welding, or medium-frequency pressure welding, and
thereafter connecting the connection piece to the at least one of the structural parts by fusion welding.

13. The process according to claim 12, wherein the fusion welding is laser-beam welding.

14. The process according to claim 12, wherein the connection piece has a carbon content such that the connection piece can be welded by conventional welding methods.

15. The process according to claim 14, wherein the connection piece is produced from a 16MnCr5 steel.

16. The process according to claim 12, wherein the connection piece is welded to one end face of the torsion bar spring.

17. The process according to claim 12, wherein the connection piece is welded to the circumference of the torsion bar spring.

18. The process according to claim 13, wherein a connection layer is applied to the torsion bar spring instead of said connection piece.

19. The process according to claim 18, wherein the torsion bar spring is heat-treated and finally machined after welding to the connection piece or application of the connection layer.

20. The process according to claim 13, wherein the torsion bar spring is arranged in a bore of a hub or bearing sleeve, defining one of said structural parts, which is an integral part of a pivot bearing of an armature of an actuator which actuates a gas-exchange valve of an internal combustion engine.

21. The process according to claim 20, wherein the hub or bearing sleeve is pivotably mounted at one end, on its outer circumference, by a bearing in a housing, defining another of said structural parts, and is connected in its bore to one end of the torsion bar spring in the region of the bearing.

22. The process according to claim 21, wherein the torsion bar spring is connected at its other end to the housing, and the hub or the bearing sleeve is pivotably mounted in its bore near the other end on the torsion bar spring by a bearing.
